(19) United States
(12) Patent Application Publication
(10) Pub. No.: US 2014/0027371 A1
(43) Pub. Date: Jan. 30, 2014

(54) COARSE AND FINE SCREEN ASSEMBLY

(71) Applicant: ROBERTO GATTO, Campagnola Emilia (RE) (IT)

(72) Inventor: ROBERTO GATTO, Campagnola Emilia (RE) (IT)

(21) Appl. No.: 13/561,807

(22) Filed: Jul. 30, 2012

(51) Int. Cl. B01D 29/00

(52) U.S. Cl. 210/323.1

(57) ABSTRACT

A screen assembly configured to separate coarse (larger) and fine (small) materials from an effluent flow. The assembly includes a plurality of bars having different heights. The bars are arranged to form larger spaces for separating coarser material from the effluent flow, and arranged to form smaller spaces for separating finer materials from the effluent flow. The effluent flows into the larger spaces first, and subsequently flows out of the smaller spaces. The assembly includes a cleaning device operable to remove the materials from both the large and small spaces.

### BACKGROUND OF THE INVENTION

1. Field of the Invention

Embodiments of the invention generally relate to a screen assembly operable to separate both coarse (e.g. large) and fine (e.g. small) materials from an effluent stream.

2. Description of the Related Art

Existing screen assemblies are generally configured to separate debris greater than only one particular size from an effluent stream. The screen assemblies generally include numerous bars that are evenly spaced apart. As the effluent passes through the spaces between the bars, debris in the effluent that is too large to pass through the spaces are retained by the bars and then removed from the assembly.

Multiple screen assemblies are used to separate out different sizes of debris from the effluent stream. For example, one screen assembly having a larger spacing between the bars is used to separate large debris from the effluent stream, and a second, separate screen assembly having a smaller spacing between the bars is used to separate smaller sized debris from the effluent stream. The two separate screen assemblies are arranged to remove the large debris first and then remove the smaller debris after.

The reason for using two separate assemblies is because the screen with the smaller bar spacing can be damaged by large debris, and is more easily clogged by large debris. The advantage of the smaller bar spacing, however, is a higher degree of debris capture. Having two separate screen assemblies increases costs due to the space required for the layout, as well as the double maintenance and assembly requirements.

Therefore, there is a need for a new and improved screen assembly.

### SUMMARY OF THE INVENTION

Embodiments of the invention include a screen assembly comprising a support member; a plurality of first bars coupled to the support member; a plurality of second bars coupled to the support member, wherein the second bars have a height different than a height of the first bars, and wherein the first and second bars are arranged to remove material from a fluid stream flowing between the first and second bars; and a cleaning device operable to remove material from the first and second bars.

Embodiments of the invention include a screen assembly comprising a support member; a plurality of first and second bars coupled to the support member and arranged such that fluid flows into larger spaces formed between the first bars and flows out of smaller spaces formed between the first and second bars; and a cleaning device operable to remove material separated from the fluid flow by the first and second bars.

### BRIEF DESCRIPTION OF THE DRAWINGS

So that the manner in which the above recited features of the invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a front view of a screen assembly.

FIG. 2A is a side sectional view of the screen assembly taken along line 2A-2A illustrated in FIG. 1.

FIG. 2B is a sectional view of the screen assembly taken along line 2B-2B illustrated in FIG. 2A.

FIG. 2C is a sectional view of the screen assembly taken along line 2C-2C illustrated in FIG. 2A.

FIG. 2D is an enlarged portion of the screen assembly illustrated in FIG. 2C.

### DETAILED DESCRIPTION

Embodiments of the invention relate to a screen assembly configured to separate materials (such as debris or solids) of different sizes from an effluent stream (such as a liquid stream). In particular, the screen assembly may include a plurality of bars spaced apart for permitting effluent flow through the bar spaces. Materials, such as debris, that are too large to pass through the bar spaces are captured by the upper surfaces of the bars and/or the spaces between the bars. The bars have different heights to capture materials of different sizes. The materials captured by the bars are removed by a cleaning device, such as a rake or comb, that moves along adjacent the upper surfaces of the bars.

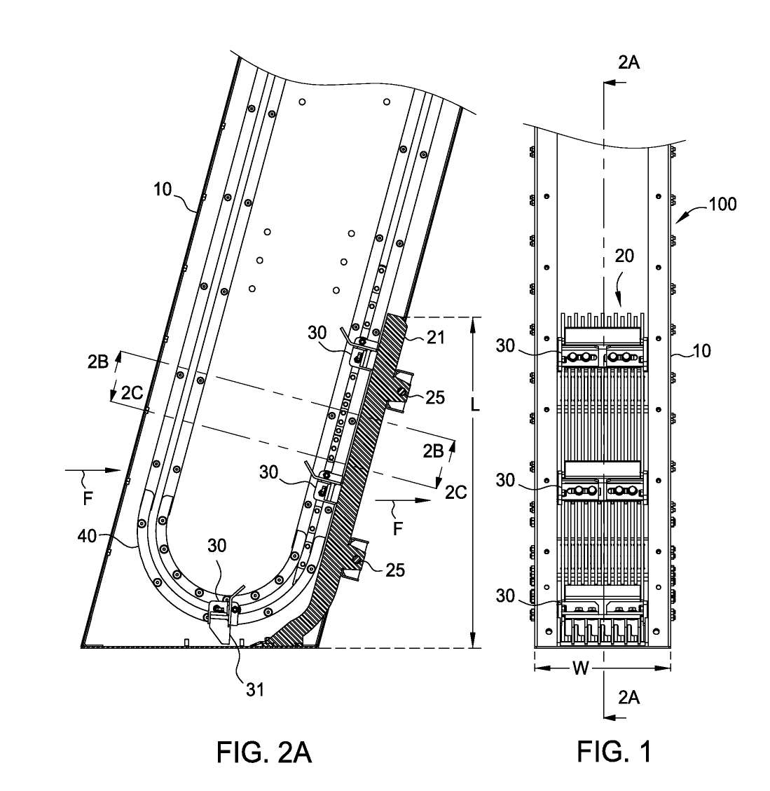

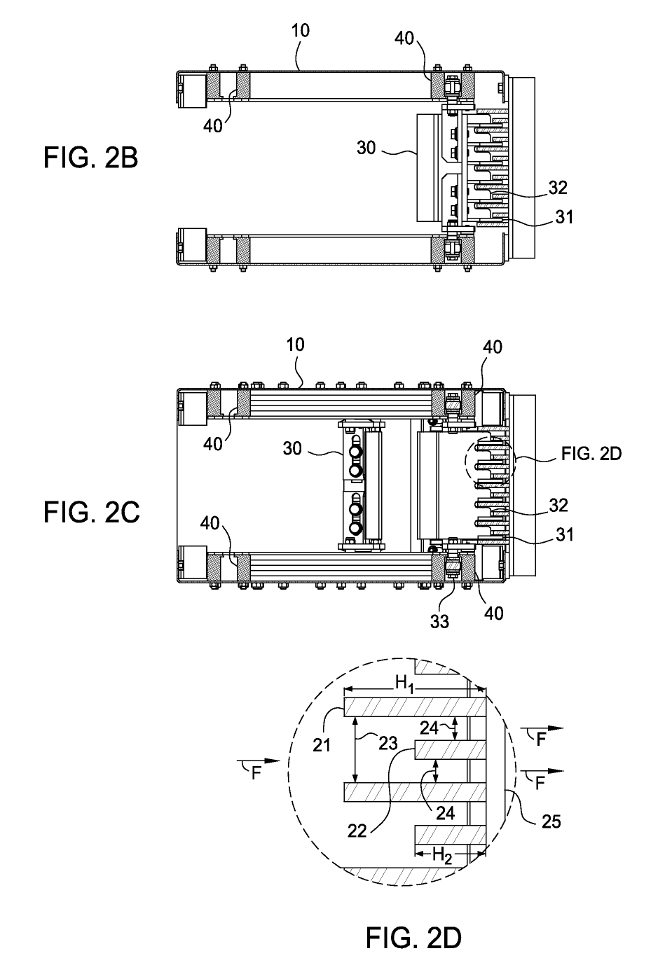

FIG. 1 is a front view of a screen assembly 100. The screen assembly 100 may generally include a support structure 10 (such as a frame), a plurality of bars 20, and one or more cleaning devices 30. The screen assembly 100 may be disposed in a channel or waterway having a width similar to the width “W” of the screen assembly 100. An effluent stream may flow through the channel or waterway, and flow through the screen assembly 100 as indicated by flow arrow “F” illustrated in FIG. 2A. Materials (such as debris) in the effluent stream are captured and separated by a plurality of bars 20 of the screen assembly 100. The effluent stream may have a depth similar to the length “L” of the bars 20 illustrated in FIG. 2A. Each cleaning device 30 may move along the bars 20 to remove the materials captured by the screen assembly 100.

FIG. 2A is a sectional view of the screen assembly 100. As illustrated, one or more support members 25 (such as rods) are used to support and/or connect the bars 20 together. The bars 20 may be evenly spaced apart, or may have a different spacing between one or more of the bars 20. The bar spacing determines the sizes of materials that may flow, and thus the sizes of materials that may not flow, through the screen assembly 100. One bar 21 is shown, having a lower end coupled to the support structure 10, and vertically oriented at a slight angle to an upper free end.

Each cleaning device 30 may include a plurality of cleaning members 31, 32 (such as fingers) that are used to remove materials captured by the bars 20, and thereby permit unobstructed effluent flow through the screen assembly 100. The cleaning devices 30 may lift the material to a discharge bin or other similar waste removal container coupled to or disposed adjacent to the screen assembly 100. The cleaning devices 30 may be movable along a track 40 using methods known in the art, such as by motors, gears, rollers, chains and/or other similar operating systems. The track 40 may include a continuous loop so that the cleaning devices 30 may be operated continuously to prevent clogging of the screen assembly 100.

FIGS. 2B and 2C illustrate sectional views of the screen assembly 100. FIG. 2B illustrates a view of one of the cleaning devices 30 from below, and FIG. 2C illustrates a view of two of the cleaning devices 30 from above. Each cleaning device 30 may include one or more connection members 33 for securing the body of the cleaning device 30 to the track 40. The cleaning members 31, 32 may also be coupled to the body of the cleaning device 30 adjacent to each other, such as by threaded, bolted, welded, or other similar connections known in the art. The cleaning members 31, 32 are configured to remove material from the spaces between bars 20. In particular, the cleaning members 31 may be larger in length, width, and/or height than the cleaning members 32 to remove material from the bar spaces of one desired size, while the cleaning members 32 may include a different size/shape to remove material from bar spaces of a different size.

In one embodiment, each cleaning device 30 may be configured to simultaneously remove material from all of the spaces between the bars 20. In one embodiment, one cleaning device 30 may be configured to remove material from a first set of bar spaces, and a second cleaning device 30 may be configured to remove material from a second set of bar spaces. In one embodiment, the cleaning members 31 may be configured to remove material from one or more bar spaces, and the cleaning members 32 may be configured to remove material from one or more other bar spaces. In one embodiment, the cleaning members 31, 32 may jointly or individually remove material from all or a portion of one or more of the bar spaces.

FIG. 2D illustrates the spaces between the bars 20 with the cleaning device 30 removed for clarity according to one embodiment. A first plurality of bars 21 may include a first height H1, and a second plurality of bars 22 may include a second height H2 that is different than, such as less than, the first height H1. The first plurality of bars 21 may be evenly spaced apart from each other to form a space 23. In one embodiment, the spaces 23 may have a width of about 10-12 millimeters to about 50-75 millimeters. The second plurality of bars 22 may be disposed between the bars 21, thereby forming a space 24 between adjacent bars 21, 22. In one embodiment, the spaces 24 may have a width of about 2-5 millimeters to about 10-25 millimeters. Each space 23 formed by two adjacent bars 21 may be integral with or in communication with two spaces 24 formed by one bar 22 disposed between the two adjacent bars 21. Fluid may flow into the spaces 23 before flowing into spaces 24. Fluid may flow into the spaces 23 and may flow out of the spaces 24 in the direction of flow arrows F through the screen assembly 100.

Material, such as debris, in the effluent stream may be filtered out by the bars 21, 22. Material that is too large to flow into the spaces 23 may be captured by the bars 21, and may be prevented from contacting the bars 22. Material that can flow into the spaces 23 but that is too large to flow into the spaces 24 may be captured by the bars 21, 22. Depending on the size/shape/type of materials in the effluent stream, some material may flow into the spaces 23 but may be captured by the sidewalls of the bars 21 without contacting the bars 22. Similarly, some material may flow into the spaces 24 but may be captured by the sidewalls of the bars 21, 22 rather than flow through the screen assembly 100. In this manner, the screen assembly 100 is configured to separate materials of different sizes from an effluent stream using a single screen unit.

In one embodiment, the bars 21 can remove larger or coarse sized material, and the bars 21, 22 can remove smaller or fine sized material. In one embodiment, the bars 22 may be disposed between two, three, four, or more bars 21 and vice versa. In one embodiment, the bars 21, 22 may be arranged in any order to form one or more spaces 23, 24 and/or other sized spaces configured to separate materials of different sizes from an effluent stream. In one embodiment, a third, fourth, or fifth plurality of bars may be used having heights that are different, such as less than or greater than, the heights of the bars 21, 22, thereby forming other spaces with the bars to capture even more materials of different sizes using a single screen unit. In one embodiment, the bars may be symmetrically or asymmetrically spaced apart. In one embodiment, the lengths and/or widths of one or more of the bars may be the same as or different than one or more of the other bars.

As stated above, the cleaning devices 30 may be continuously operated to remove materials from the effluent stream that are captured by the bars 20 and thereby clean the screen assembly 100. The cleaning devices 30 may be moved along the longitudinal length of the bars 20 such that the cleaning members 31 extend through spaces 23 and into spaces 24, and such that the cleaning members 32 extend into spaces 23. The combination of the cleaning members 31, 32 may simultaneously remove materials disposed on the bars 20 and within both spaces 23, 24. The cleaning members 31, 32 may move or lift the materials along the longitudinal length of the bars 20, out of the effluent flow, and into a discharge bin or other similar waste removal container coupled to or disposed adjacent to the screen assembly 100.

In one embodiment, the cleaning devices 30 may include one or more cleaning members 31, 32 dimensioned/configured to remove materials separated by any arrangement and/or spacing of the bars described above. In one embodiment, the cleaning members 31, 32 may be symmetrically or asymmetrically spaced apart. In one embodiment, the heights, lengths, and/or widths of one or more of the cleaning members 31, 32 may be the same as or different than one or more of the other cleaning members 31, 32.

While the foregoing is directed to embodiments of the invention, other and further embodiments of the invention may be devised without departing from the basic scope thereof, and the scope thereof is determined by the claims that follow.

1. A screen assembly, comprising:
a support member;
a plurality of first bars coupled to the support member;
a plurality of second bars coupled to the support member, wherein the second bars have a height different than a height of the first bars, and wherein the first and second bars are arranged to separate material from fluid flowing between the first and second bars; and
a cleaning device operable to remove material from the first and second bars.

2. The assembly of claim 1, wherein at least one of the second bars is disposed between at least two of the first bars such that a larger space is formed between the first bars and a smaller space is formed between the first and second bars.

3. The assembly of claim 1, wherein the first bars are arranged to form a plurality of first spaces that have a width greater than a plurality of second spaces formed between the first and second bars.

4. The assembly of claim 3, wherein the cleaning device includes one or more cleaning members configured to remove material disposed in the first and second spaces.

5. The assembly of claim 1, wherein the height of the second bars is less than the height of the first bars, and wherein each of the first bars are separated by at least one second bar.

6. The assembly of claim 5, wherein a larger space is formed between the first bars and a smaller space is formed between the first and second bars such that fluid flows into the larger space before flowing into the smaller space.

7. The assembly of claim 1, wherein the first and second bars are arranged substantially parallel to each other and form a plurality of large and small spaces such that fluid flows into the larger spaces and flows out of the smaller spaces.

8. The assembly of claim 1, further comprising a track coupled to the support member, wherein the cleaning device is movable along the track to remove material disposed between the first and second bars.

9. The assembly of claim 1, wherein the cleaning device includes a plurality of first cleaning members arranged to remove material disposed between the first bars, and a plurality of second cleaning members arranged to remove material disposed between the first and second bars.

10. A screen assembly, comprising:
a support member;
a plurality of first and second bars coupled to the support member and arranged such that fluid flows first into larger spaces formed between the first bars and then flows out of smaller spaces formed between the first and second bars; and
a cleaning device operable to remove material separated from the fluid flow by the first and second bars.

11. The assembly of claim 10, wherein at least one of the second bars is disposed between at least two of the first bars such that a larger space is formed between the first bars and a smaller space is formed between the first and second bars.

12. The assembly of claim 10, wherein the cleaning device includes one or more cleaning members configured to remove material disposed in the larger and smaller spaces.

13. The assembly of claim 10, wherein the height of the second bars is less than the height of the first bars, and wherein each of the first bars are separated by at least one second bar.

14. The assembly of claim 10, wherein the height of the second bars is less than the height of the first bars, and wherein each of the second bars are disposed between at least two first bars.

15. The assembly of claim 10, further comprising a track coupled to the support member, wherein the cleaning device is movable along the track to remove material from the first and second bars.

16. The assembly of claim 10, wherein the cleaning device includes a plurality of first cleaning members arranged to remove material disposed between the first bars, and a plurality of second cleaning members arranged to remove material disposed between the second bars.

17. The assembly of claim 10, wherein the cleaning device includes at least one cleaning member arranged to remove material disposed within the larger spaces, the smaller spaces, or both the larger and smaller spaces.
